(19) United States
(12) Patent Application Publication
(10) Pub. No.: US 2005/0261945 A1
(43) Pub. Date: Nov. 24, 2005

(54) Method and device for booking a parking space

(76) Inventors: Thierry Mougin, Saint Vit (FR); Bertil De Fos, Rome (IT); Axel Hausen, Mörfelden Walldorf (DE)

Correspondence Address: OSHA LIANG L.L.P., 1221 MCKINNEY STREET, SUITE 2800, HOUSTON, TX, 77010, US

(21) Appl. No.: 10/399,310

(22) PCT Filed: Oct. 15, 2001
(86) PCT No.: PCT/IB01/01930

§ 371 Date: Apr. 15, 2003

(30) Foreign Application Priority Data
Oct. 16, 2000 (FR) 00/13234

(51) Int. Cl. G06F 17/60

(52) U.S. Cl. 705/5

(57) ABSTRACT

The invention concerns a method whereby: at user level, a request booking (2) a parking space is specified according to selected parameters, and the resulting specified booking request is sent to the central unit (5), at the central reservation unit (5), receiving the specified booking request, a reservation code (RC) is produced for a free parking space corresponding to said selected parameters, and said produced reservation code (RC) is sent to the user; at user level the reservation code (RC) and is received and presented to the access control device (12) associated with the corresponding parking space; at access control, the reservation code (RC) presented by the user is verified, and, if verification is positive, access to the booked parking space is authorised.

This invention concerns the booking of a parking space.

Mobility is a major concern of today's transport companies, cities and car park operators.

More often than not, access to parking spaces is not easy. For instance, queues of cars waiting for a space to become free can frequently be seen at car park entries.

The parking needs of many motorists are however foreseeable. A significant number of motorists plan their journey in advance. For instance, many of them know that they will be going to a definite place and have a clear idea of their time of arrival and when they will leave.

That is why the Applicant set out to provide a system for booking a parking space that would facilitate mobility, make it easier for motorists to have access to car parks and improve the management of car parks.

This invention is precisely aimed at providing that solution.

First of all, it concerns a method for booking a parking space.

According to the general definition of the invention, the method includes the following:
a. providing a central reservation unit and an access control device for booking at least one parking space;
b. as regards the user, defining a booking request for a parking space that meets selected parameters and sending the defined booking request to the central reservation unit;
c. as regards the central reservation unit, receiving the booking request defined as described above, preparing a reservation code for a vacant parking space that meets the said selected parameters and sending the said reservation code to the user;
d. as regards the user, receiving the reservation code and presenting it to the access control device associated with the corresponding parking space; and
e. as regards the access control device, verifying the reservation code presented to it by the user and if the identification is positive, permitting access to the reserved parking space.

The method based on the invention therefore makes it possible to automatically link a request for a parking space with the spaces vacant (information flowing up), allocate the booking to the selected car park (information flowing down) and execute the booking (i.e. give the user access to the reserved parking space). Also, the method makes it possible to immediately determine if a space meeting the selected parameters is available in order to allocate it to a requesting user.

In practice, the booking request parameters relate to the destination, date, duration, associated service, payment method and/or booking price. The method preferably also includes a confirmation request stage where the central reservation unit sends the user a confirmation request before sending the reservation code and the said reservation code is only sent to the user after the user confirms the booking.

According to one embodiment of the invention, the request for booking a parking space is accompanied by a user identifier.

According to another aspect of the invention, the reservation code is calculated on the basis of the identifier of the user and at least some of the parameters that define the booking request.

In practice, reservation code verification is a reverse function of the reservation code calculation.

In practice, the use of the reservation code is limited in terms of frequency and/or time.

This invention also covers a device for booking a parking space in order to implement the method described above.

One of the important characteristics of the parking space booking device is that it includes an access control device that is associated with at least one parking space to be booked and a central reservation unit, which central reservation unit is capable of receiving parking space booking requests with selected parameters from users, preparing a reservation code for the parking space that meets the said selected parameters and sending the said reservation code to the user; the said access control device associated with the corresponding parking space is capable of verifying the reservation code presented by the user and if the verification is positive, authorising access to the reserved parking space or at least giving an access right to the user.

In practice, the reservation device includes an access closing device, the opening and closing of which is controlled by the access control device.

The central reservation unit preferably includes a communication portal that can communicate with the user through at least one means of communication belonging to the group formed by means for wired and/or wireless telephony, data exchange, facsimile transmission, voice recognition, wired and/or wireless Internet or similar means.

As an advantage, the central reservation unit is capable of calculating the reservation code on the basis of the user identifier and the parameters defining the booking request.

According to another aspect of the invention, the access control device is capable of establishing a reverse function of the reservation code calculation to verify the said reservation code.

The central reservation unit preferably also includes a database containing the data relating to the requests and the associated reservation codes, which database can be created, referred to, processed and used by the user and/or the operator who manages the parking spaces.

The database or booking agenda, which may be updated by the car park operator, is a tool that enables the central reservation unit to issue bookings.

According to another aspect of the invention, the access control system also includes means of communication connected to the operator and/or the central communication unit for transferring data relating to the availability of parking spaces, the results of reservation code verification or statistics about the use of the reservation device.

Other characteristics and advantages of the invention will become evident in the light of the detailed description below and the drawings, where:

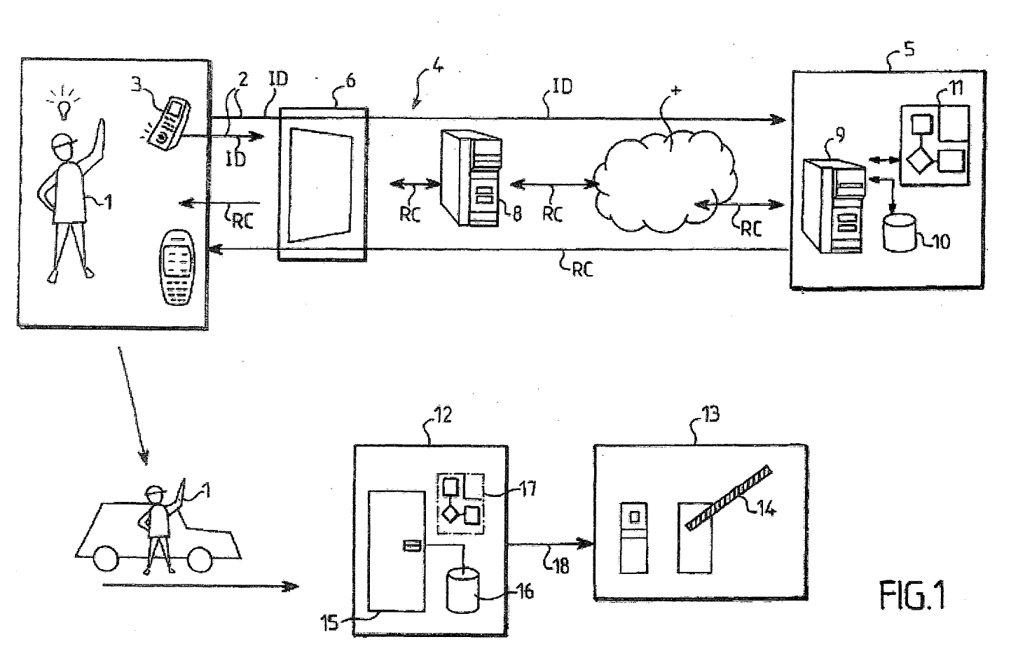

FIG. 1 is a schematic view illustrating the parking space booking method based on the invention;

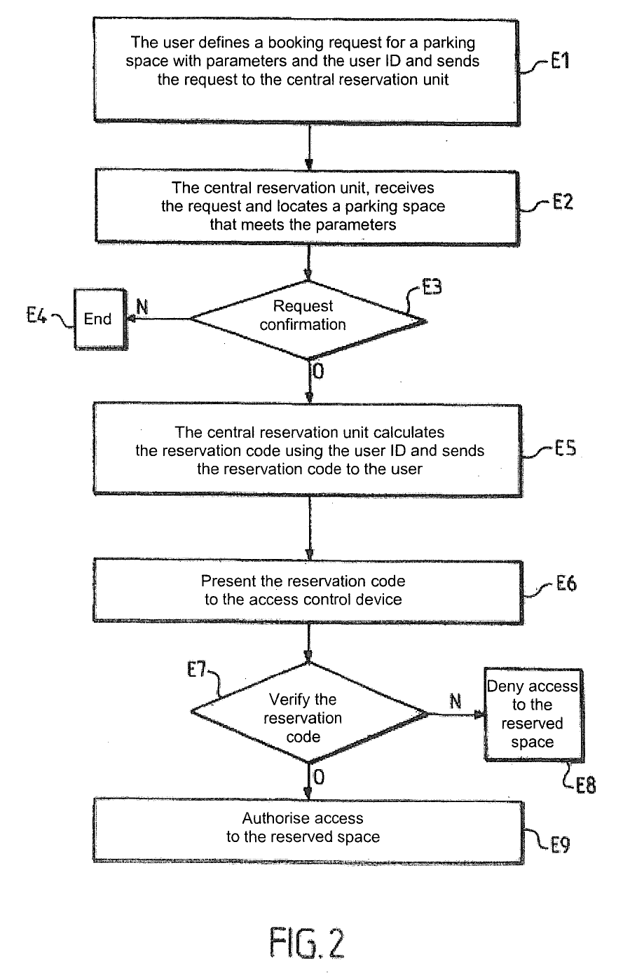

FIG. 2 is an organisation chart illustrating the parking space booking method based on the invention;

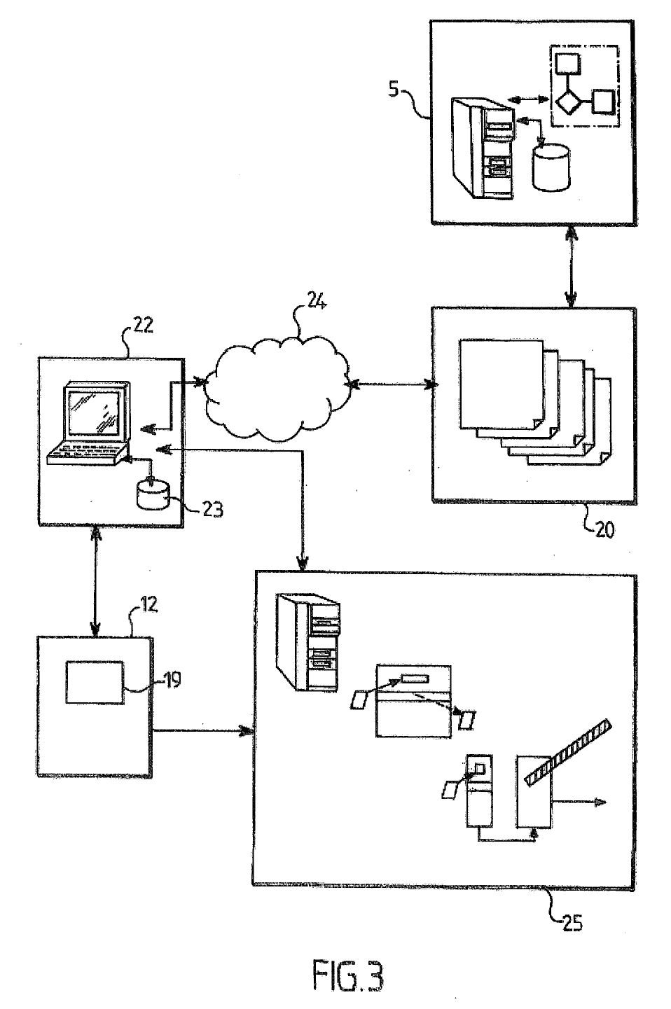

FIG. 3 is a schematic view of the management means and the reservation device based on the invention.

This invention gives the motorist the possibility to book at least one parking space in advance in a car park or similar system.

The motorist (user 1) defines his/her request 2 on a query device 3, which can for instance be of the multimedia type.

Request 2 takes account of the needs of user 1, such as: Where does user I want to go? When does user 1 want to arrive there? How long does user 1 want to stay there? When does user 1 want to leave? What payment method does user 1 want to use? What type of service does user 1 expect?

Communication 4 (or exchange of information) between the query device 3 used by user I and the central reservation unit 5 can take place using a variety of methods.

For example, communication 4 may require the user and the central reservation unit to have multimedia means of communication that handle voice transmissions, facsimile transmissions, wired or wireless communication via the internet, data communication, electronic mail or similar means. In practice, the means are able to convert the user's request into an appropriate format to exchange information with the central reservation unit.

An access portal 6, placed between the user and the central reservation unit, may provide access to the said central reservation unit 5 via Internet-type communication or any other means of communication 7. The portal may be fitted with processing and storage means 8 in order to store the data about users and profile the users.

Central reservation unit 5 includes processing means 9 that can receive the booking request, process it and store it in memory 10.

Central reservation unit 5 is capable of locating the best vacant parking space that meets the parameters defined by the user.

That search could be based on a database 20, described in greater detail below. This database or booking agenda could be accessible to the car park operator through a communication network or portal such as the Internet for example.

Central reservation unit 5 can send the user, via portal 6 if required, offers of one or more spaces available for booking, which best meet the needs of the user.

Where applicable, user 1 will confirm the offer that is suited to his/her needs.

Booking request 2 may be accompanied by the user's identification (ID). The ID could be the name of the user, the identifier of a payment card, a mobile telephone number, a mobile telephone identifier or the payment associated with the booking.

Central reservation unit 5 uses appropriate calculation means 11 to calculate a reservation code (RC) that could be based on the user identifier and/or at least some of the request parameters, particularly information relating to the car park, the date and duration and the services associated with the booking.

Calculation means 11 may be cryptography means used conventionally for data security.

Reservation code RC is given to the user. It may be stored using different methods, e.g. noted on paper or stored in a device capable of storing such data, such as a mobile telephone, a smart card, a personal digital assistant etc. The code could be entered manually (e.g. with a manual keypad) or automatically (magnetic entry, bar code or similar), in order to be communicated to an access control device that will be described in further detail below.

When the user arrives at the entry of the car park or similar system with at least one space available that meets the booking request, the said user stops before an access control device 12 which is capable of controlling the opening/closing of a device 13 that bars access to the reserved parking space.

For example, the device 13 that bars access could include an automatically opening and closing barrier 14 (door or grille). The barrier is capable of barring access to a car park containing several spaces or a barrier (on the ground, for example), that can prevent access to an individual space.

The user may divulge his or her identity to the access control device with identification. Identifier ID may also be transmitted through different means that may be physical, magnetic and/or optical.

The user enters reservation code RC on the user interface 15 of the access control device. For example, the said user interface 15 could include a smart card reader, a contactless card reader, a scanner, an infrared communication device, a keypad, a voice recognition system or a data exchange device using the Bluetooth protocol or a similar protocol.

Access control device 12 includes a memory 16 and calculation means 17 that is capable of using reservation code RC and establish the reverse function of the calculation used to create the reservation code in order to verify if access is authorised or not.

Several conditions may be verified before authorising access. These conditions may concern the identifier ID, the method and validity of payment or other parameters relating to the query from the user or the particular status of the user.

The access control device may also interact dynamically with a video monitoring and detection device or a similar device that instantly indicates the spaces available in the car park that meet the booking request.

If the reservation code is identified positively, access control device 12 moves the access closing device 13 (gate, barrier or grille) to enable the user to enter the corresponding vacant space.

Control 18 may be direct (i.e. the access control device directly controls the opening/closing of the barrier) or indirect (i.e. the access control device acts, for example, as a terminal issuing an entry right (ticket, token, data etc.) to be presented to the access closing device.

Direct control of the closing device may take the form of status information such as a high logical signal on a two-wire communication line connecting access control device 12 and barrier 13 or more complete information that is associated with the type of booking or payment. Direct control could also be an electronic message sent by the access control device to the access closing device.

Indirect control of the closing device may use an access right delivered by the access control device (terminal), which is then presented by the user to the closing device. The access right could be printed or encoded on a ticket or a smart card and the closing device could be fitted with a reader compatible with the access right in order to process the access right.

The access right made up by the reservation code can be transmitted to other access closing devices that can accept such access rights.

The use of the reservation code may be limited in terms of the frequency (generally a single-use right) and/or the time (valid for a predetermined date and duration).

In practice, access control device 12 reverses the operation used to calculate the reservation code during the reservation transaction between the user and the central reservation unit. Calculation algorithm 17 may be stored locally in an appropriate processing device so that no external communication is required, which would avoid the transmission of sensitive data through the networks. Access control device 12 can construct a local database 16 in order to avoid the unauthorised multiple use of a booked space.

In practice, if several access control devices are installed in a car park, a local communication system may be set up to connect the said access control devices and synchronise them.

By reference to FIG. 2, the organisation chart of the booking method according to the invention includes the following stages:

In stage E1, user 1 submits a booking request 2 for a parking space with selected parameters. The booking request defined in this way is sent to the central reservation unit, possibly with identifier ID.

In stage E2, central reservation unit 5 receives the booking request defined along with the identifier of the user if the identifier has been sent.

Where applicable, in stage E3, the central reservation unit asks for request confirmation. If the request is not confirmed, the central reservation unit aborts the procedure (stage E4). Otherwise, it moves on to stage E5.

In stage E5, the central reservation unit prepares a reservation code RC for the parking space corresponding to the selected parameters, taking account of the user identifier if applicable. The reservation code is sent to the user.

In stage E6, the user receives the reservation code. The said user then presents the reservation code to the access control device associated with the corresponding parking space.

In stage E7, the access control device verifies the reservation code.

In stage E8, if the verification is negative, access is denied. In stage E9, if the verification is positive, access to the parking space is authorised.

By reference to FIG. 3, access control device 12 may also include a communication terminal 19 to implement communication with the central reservation unit in order to collect or exchange information, perform tracing or profiling operations or perform accounting or statistics functions. As an advantage, central reservation unit 5 has a database 20 that may be indexed on the basis of identifiers and on the basis of operators, e.g. in order to conduct capacity calculations and/or perform tariff modulations.

With database 20, it is for instance possible to determine if a booking request has been received by the central reservation unit. The user can also place his or her booking in the database. For each booking made in this way, detailed information about the transaction is available (identifier, reference, payment procedure, tariffs, payment status). The information may be used by the car park operator or the portal operator 6 for the purpose of statistics, clearance, profiling or other similar purposes.

The database or booking agenda may be created and updated by the car park operator via the Internet, e. g. with a daily update of the number of spaces allocated.

Car park operator 22 may also need to refer to database 20. In that case, operator 22 can look up database 20 with appropriate processing and storage means 23 (in pull mode or push mode), through a communication network (Internet, voice, infrared or other means of communication). Such looking up could enable the operator to synchronise (refresh at an appropriate rate) and adjust the capacity of the car parks in terms of vacant spaces to suit the booking requests.

With a database such as database 20, the operator can decide to increase or decrease the number of spaces set aside for reservation during a certain period in order to optimise the response to needs.

In practice, some adjustments to the database may be required. For instance, it may be necessary to update the database in order to take account of the physical occupancy in the car park and any early or late departures.

Access control device 12 may be capable of communicating with operator 22 from time to time, on demand, depending on some data, or depending on the bookings made by users. Communication between the access control device and the central reservation unit may thus be put in place in order to exchange information with the central reservation unit in order to maintain database 20 and offer an improved service to the users.

The reservation method described in the invention makes for rapid transactions, secure calculation of the access rights with the central reservation unit and also locally with the access control device and the use of different communication means that are independent of the technology deployed (no dependence on a specific communication network is required to implement the method described in the invention).

The implementation of the method described in the invention is easy to adapt to existing car parks. The method may be integrated physically into the barrier entry terminals or other access control devices. It is totally independent of the existing management and counting systems.

The calculation algorithm used to verify the reservation code (e.g. security cryptography) may be located in any processing terminal, which offers great implementation flexibility and full independence from closing systems and communication networks. At least some part of the reservation code can be managed with the help of a smart card of the Secure Application Module type, containing software for authenticating reservation codes.

Also, the access control device does not need a physical link or communication with the central reservation unit that has created the reservation code.

The access control device can also play the role of an access terminal that issues tickets for controlling the access closing barrier. The access control device may also act as an automatic pay station or control keypad for an access closing barrier.

It is not indispensable to identify the user, as payment of the reservation can act as identification and validation of the transaction.

Management operations (creation, modification, reservation) can be performed from the central reservation unit (with or without the database) without requiring a complex interface between the central reservation unit and the existing closing systems.

The reservation method based on the invention can also act as the payment method for a selected service.

Besides, the reservation method described in the invention may be used to book spaces in parking areas that are not enclosed by barriers (e.g. areas with Pay & Display machines). Likewise, the said method can be used for individual access closing devices that are associated with a space to be allocated.

1. A method for booking a parking space, characterised by the fact that it includes the following stages:
a. providing a central reservation unit and an access control device for at least one parking space to be reserved;
b. as regards the user, defining a booking request for a parking place with the selected parameters and sending the booking request defined in this way to the central reservation unit;
c. as regards the central reservation unit, receiving the booking request defined as described above, preparing a reservation code (RC) for a vacant parking space that meets the selected parameters and sending the said reservation code (RC) to the user;
d. as regards the user, receiving the reservation code (RC) and presenting it to the access control device associated with the corresponding parking space; and
e. as regards the access control device, verifying the reservation code (RC) presented in this way by the user and, if the verification is positive, authorizing access to the parking space reserved in that way.

2. The method described in claim 1, characterised by the fact the booking request parameters relate to the destination, date, duration, association service, payment method and/or the price of the booking.

3. The method described in claim 1, characterised by the fact that it further includes a stage in which a confirmation request is sent to the user by the central reservation unit before the reservation code is sent to the user, where the said reservation code is only sent to the user if the user confirms his or her booking.

4. The method described in claim 1, characterised by the fact that the booking request for a parking space is accompanied by the user's identifier (ID).

5. The method described in claim 4, characterised by the fact that the reservation code calculation takes account of the user's identifier (ID) and at least some of the parameters defining the booking request.

6. The method described in claim 1, characterised by the fact that the reservation code verification is a reverse function of the reservation code calculation.

7. The method described in claim 1, characterised by the fact that the user of the reservation code is limited in terms of frequency and/or in time.

8. A device for booking a parking space, characterised by the fact that it includes an access control device associated with at least one parking space to be booked and a central reservation unit and that the said reservation unit is capable of receiving a booking request for a parking space defined according to the selected parameters, preparing a reservation code (RC) for a vacant parking space that matches the said selected parameters and sending the said reservation code to the user and that the access control device associated with the corresponding parking space is capable of verifying the reservation code presented by the user and, if the verification is positive, authorising access to the parking space reserved in this way or at least issuing an access right to the user.

9. The device according to claim 8, characterised by the fact that it includes an access closing device, the opening and closing of which is controlled by the access control device.

10. The device described in claim 8, characterised by the fact that the central reservation unit includes a communication portal that is capable of communicating with the user with at least one means of communication belonging to the group formed by means for wired and/or wireless telephony, data exchange, facsimile transmission, voice recognition, wired and/or wireless Internet type communication devices and similar means.

11. The device described in claim 8, characterised by the fact that the central reservation unit includes calculation means that can calculate the reservation code (RC).

12. The device described in claim 8, characterised by the fact that the access control device includes calculation means capable of establishing a reverse function of the reservation code calculation in order to verify the said reservation code.

13. The device described in claim 8, characterised by the fact that the central reservation unit further includes a database that can contain data relating to requests and associated reservation codes, which database is likely to be created, referred to, processed and used by the user and/or operator who manages the parking spaces.

14. The device described in claim 8, characterised by the fact that the access control device further includes a communication terminal that is connected to the operator and/or the central communication unit so as to transfer data relating to the availability of parking spaces, the results of the reservation code verification, statistics or similar data.

15-18. (canceled)

19. An access control device designed to cooperate with a device for booking a parking space, characterised by the fact that it includes the access control device associated with at least one parking space to be booked and a central reservation unit and that the said reservation unit is capable of receiving a booking request for a parking space defined according to the selected parameters, preparing a reservation code (RC) for a vacant parking space that matches the said selected parameters and sending the said reservation code to the user and that the access control device associated with the corresponding parking space is capable of verifying the reservation code presented by the user and, if the verification is positive, authorising access to the parking space reserved in this way or at least issuing an access right to the user.

20. A central reservation unit designed to cooperate with a device for booking a parking space, characterised by the fact that it includes an access control device associated with at least one parking space to be booked and the central reservation unit and that the said reservation unit is capable of receiving a booking request for a parking space defined according to the selected parameters, preparing a reservation code (RC) for a vacant parking space that matches the said selected parameters and sending the said reservation code to the user and that the access control device associated with the corresponding parking space is capable of verifying the reservation code presented by the user and, if the verification is positive, authorising access to the parking space reserved in this way or at least issuing an access right to the user.

21. An access closing device designed to cooperate with a device for booking a parking space, characterised by the fact that it includes an access control device associated with at least one parking space to be booked and a central reservation unit and that the said reservation unit is capable of receiving a booking request for a parking space defined according to the selected parameters, preparing a reservation code (RC) for a vacant parking space that matches the said selected parameters and sending the said reservation code to the user and that the access control device associated with the corresponding parking space is capable of verifying the reservation code presented by the user and, if the verification is positive, authorising access to the parking space reserved in this way or at least issuing an access right to the user and characterized by the fact that it includes the access closing device, the opening and closing of which is controlled by the access control device.

22. A communication portal designed to cooperate with a device for booking a parking space, characterised by the fact that it includes an access control device associated with at least one parking space to be booked and a central reservation unit and that the said reservation unit is capable of receiving a booking request for a parking space defined according to the selected parameters, preparing a reservation code (RC) for a vacant parking space that matches the said selected parameters and sending the said reservation code to the user and that the access control device associated with the corresponding parking space is capable of verifying the reservation code presented by the user and, if the verification is positive, authorising access to the parking space reserved in this way or at least issuing an access right to the user and characterised by the fact that the central reservation unit includes that communication portal that is capable of communicating with the user with at least one means of communication belonging to the group formed by means for wired and/or wireless telephony, data exchange, facsimile transmission, voice recognition, wired and/or wireless Internet type communication devices and similar means.
